(19) United States
(12) Patent Application Publication
(10) Pub. No.: US 2015/0090555 A1
(43) Pub. Date: Apr. 2, 2015

(54) POWER TRANSMISSION SYSTEM

(71) Applicants: Yu Miyahara, Susono-shi (JP); Hiroyuki Amano, Susono-shi (JP); Hirotsugu Yoshino, Susono-shi (JP)

(72) Inventors: Yu Miyahara, Susono-shi (JP); Hiroyuki Amano, Susono-shi (JP); Hirotsugu Yoshino, Susono-shi (JP)

(73) Assignee: TOYOTA JIDOSHA KABUSHIKI KAISHA, Aichi (JP)

(21) Appl. No.: 14/397,944

(22) PCT Filed: May 17, 2012
(86) PCT No.: PCT/JP2012/062594

§ 371 Date: Oct. 30, 2014

(51) Int. Cl. F16H 45/02

(52) U.S. Cl. CPC F16H 45/02; F16H 2045/0226; F16H 2045/0263; F16H 2045/0231; F16H 2045/0252
USPC 192/3.28

(57) ABSTRACT

A power transmission system having a pendulum damper is provided. A rolling member of the pendulum damper is arrange in a rotary member, and a vibration damping performance of the pendulum damper is enhanced by increasing an inertia moment of the rolling member to be larger than that of the rotary member. The power transmission system is comprised of a hydraulic route for transmitting power between an input member and an output member through a fluid coupling, a mechanical route for transmitting power between the input member and the output member by engaging a lockup clutch, a pendulum damper that damps torsional vibrations of the output member by an oscillating motion caused by the torsional vibrations, and an elastic damper that damps the torsional vibrations by a relative rotation between a drive member and a driven member connected through an elastic member. The pendulum damper is disposed on the mechanical route, and one of the lockup clutch and the elastic damper is disposed on an output side of the pendulum damper.

### TECHNICAL FIELD

The present invention relates generally to a system for transmitting power, and more particularly, to a power transmission system having a fluid coupling and a damper for damping torsional vibrations of a rotary member by a reciprocating motion of a rotary member arranged around the rotary member.

### BACKGROUND ART

Torsional vibrations on a rotary member such as a drive shaft for transmitting torque of a prime mover are caused by torque pulses resulting from driving the prime mover connected to the rotary member. One example of a damper for damping such torsional vibrations on the rotary member is described in Japanese Patent Laid-Open No. 2011-504986.

According to the teachings of Japanese Patent Laid-Open No. 2011-504986, a damper device as a centrifugal pendulum device comprised of a speed adaptive absorber and two dampers is arranged in a torque converter having a lockup clutch. The damper device is further comprised of a support device connected to a turbine runner of the torque converter, and an inertial mass supported by the support device while being allowed to be oscillated by the vibrations of the support device. The centrifugal pendulum device will be called a “pendulum damper” in the following explanation. The damper is comprised of a drive member and a driven member connected while being allowed to rotate relatively, and elastic members are interposed therebetween. Those elastic members are compressed by a relative rotation between those drive and driven members.

In the damper device taught by Japanese Patent Laid-Open No. 2011-504986, the support device is rotated integrally with the turbine runner, and an inertia moment of the turbine runner is added to an inertia moment of the support device. That is, according to the damper device taught by Japanese Patent Laid-Open No. 2011-504986, a ratio of the inertia moment of the rolling member to the inertial moment of the support device on which the rolling member is arranged has to be reduced. Therefore, a desired vibration damping performance of the damper device may not be achieved.

### DISCLOSURE OF THE INVENTION

The present invention has been conceived noting the foregoing technical problem, and it is therefore an object of the present invention is to improve a vibration damping performance of a pendulum damper of a power transmission system by increasing an inertia moment of a rolling member relatively with respect to an inertia moment of a member in which the rolling member is arranged.

The power transmission system of the present invention is comprised of: a hydraulic route for transmitting power between an input member and an output member through a fluid coupling adapted to transmit power by rotating a turbine runner by a fluid flow created by a pump impeller; a mechanical route for transmitting power between the input member and the output member by mechanically connecting the input member and the output member by engaging a lockup clutch; a pendulum damper that damps torsional vibrations of the output member or a rotary member rotated integrally therewith by a circumferential oscillating motion of a rolling member caused by the torsional vibrations; and an elastic damper that damps the torsional vibrations by a relative rotation between a drive member and a driven member connected through an elastic member. In order to achieve the above-explained objective, according to the present invention, the pendulum damper is disposed on the mechanical route in series with the lockup clutch between the input member and the output member. In addition, at least any one of the lockup clutch and the elastic damper is disposed on an output side of the pendulum damper.

Rest of the lockup clutch or the elastic damper is disposed on an input side of the pendulum damper.

Optionally, another elastic damper may be arranged in the power transmission system of the present invention. In this case, for example, another elastic damper may be disposed between the pendulum damper and the lockup clutch. Alternatively, another elastic damper may also be disposed on the input side of the lockup clutch disposed on the input side of the pendulum damper or, on the input side of the input member.

Specifically, the pendulum damper is arranged in the fluid coupling.

According to the present invention, the pendulum damper may be disposed on the mechanical route in series with the lockup clutch between the input member and the output member. In this case, given that the lockup clutch is in partial engagement, the rotary member will not be rotated together with the turbine runner. That is, an inertia moment of the pump impeller will not be added to the inertia moment of the rotary member in which the rolling member is arranged. Therefore, the inertia moment of the rotary member can be reduced relatively to achieve a desired vibration damping performance of the pendulum damper. For the reasons mentioned above, a slip rate of the lockup clutch in partial engagement, that is, a speed difference between the rotary member and the lockup clutch can be reduced so that a power loss resulting from a slippage of the lockup clutch can be reduced. Given that the elastic damper is disposed on an output side of the pendulum damper, the rotary member will not be rotated together with the turbine runner irrespective of engagement state of the lockup clutch. Accordingly, the inertia moment of the rotary member can be reduced relatively irrespective of engagement state of the lockup clutch. Therefore, the power loss resulting from a slippage of the lockup clutch can be reduced by reducing the above-explained speed difference. Since the vibration damping performance of the pendulum dumper is thus enhanced, the pendulum damper is allowed to be downsized and lightened in comparison with the conventional damper. Accordingly, a space required for arranging the pendulum damper can be reduced so that the design flexibility of the power transmission system can be increased. In addition, fuel economy of the vehicle having the power transmission system can be improved.

As described, according to the present invention, the lockup clutch is disposed on the mechanical route, and the pendulum damper may also be disposed on the output side of the lockup clutch in series therewith. In this case, if the lockup clutch is in partial engagement, the rotary member will not be rotated together with the pump impeller so that the inertia moment of the rotary member can also be reduced relatively to achieve a desired vibration damping performance of the pendulum damper. Therefore, the above-mentioned speed difference can also be reduced. Alternatively, it is also possible to dispose the pendulum damper on the mechanical route in series with the input side of the lockup clutch, and dispose the elastic damper on the input side of the pendulum damper. Further, it is also possible to arrange the elastic dampers on both input and output sides of pendulum damper. In other words, the pendulum damper may also be disposed between a pair of elastic dampers. Thus, the pendulum damper may be disposed on the output side of the elastic damper connected in series with the lockup clutch. In this case, the rotary member will not be rotated together with the pump impeller irrespective of engagement state of the lockup clutch. Therefore, an inertia moment of the pump impeller will not be added to the inertia moment of the rotary member so that the inertia moment of the rotary member can be reduced relatively to achieve a desired vibration damping performance of the pendulum damper.

As described, according to the present invention, the pendulum damper may be arranged in the fluid coupling. In this case, the inertia moment of the rolling member may also be increased relatively with respect to that of the rotary member to achieve a desired vibration damping performance.

### BRIEF DESCRIPTION OF THE DRAWINGS

FIG. 1 is a view schematically showing a first example of the power transmission system according to the present invention.

FIG. 2 is a view schematically showing a second example of the power transmission system according to the present invention.

FIG. 3 is a view schematically showing a third example of the power transmission system according to the present invention.

FIG. 4 is a view schematically showing a forth example of the power transmission system according to the present invention.

FIG. 5 is a view schematically showing a fifth example of the power transmission system according to the present invention.

FIG. 6 is a view schematically showing a sixth example of the power transmission system according to the present invention.

### BEST MODE FOR CARRYING OUT THE INVENTION

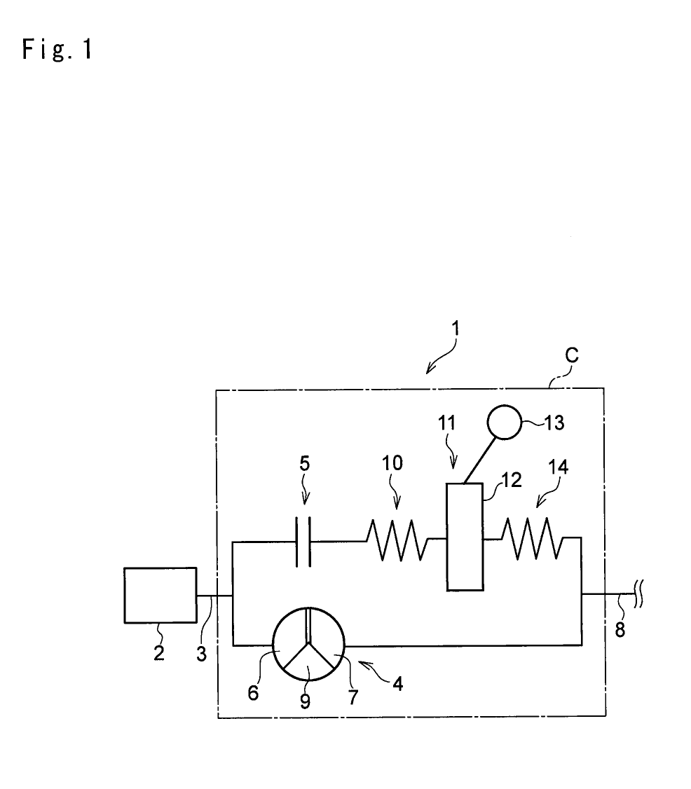

Next, preferred examples of the present invention will be explained hereinafter. Referring now to FIG. 1, there is shown the first example of the power transmission system of the present invention. As shown in FIG. 1, a torque converter 4 as a torque multiplier is connected to an output shaft 3 of a prime mover 2. For example, an internal combustion engine such as a gasoline engine, an electric motor, and a hybrid drive unit comprised of the engine and the motor may be used as the prime mover 2. In the following explanation, the prime mover 2 will simply be called the “engine” 2.

The torque converter 4 is provided with an after-mentioned lockup clutch 5. A pump impeller 6 serves as an input member of the torque converter 4, and although not shown in the drawings, a plurality of pump blades are attached to an inner face of the pump impeller 6. A pump shell is integrated with a front cover (both not shown) to form a liquid-tight casing C, and the front cover is connected to the output shaft 3 of the engine 2 to provide a power transmission therebetween.

In the casing C, a turbine runner 7 is arranged coaxially with the pump impeller 6 to be opposed thereto. The turbine runner 7 is comprised of a turbine shell having substantially same configuration as the pump shell, and a plurality of turbine blades are also attached to an inner face of the turbine shell. Therefore, the turbine runner 7 is rotated by a spiral oil flow created by the pump impeller 6. A transmission (not shown) is disposed on an output side of the torque converter 4 and an input shaft 8 of the transmission is splined to the turbine runner 7 to be rotated integrally with the torque converter 4. Accordingly, the output shaft 3 of the engine 2 serves as the input member of the invention, and the input shaft 8 of the transmission serves as the output member of the invention.

A stator 9 is interposed between the pump impeller 6 and the turbine runner 7 so that it can alter the spiral flow returning from the turbine runner 7 to the pump impeller 6. To this end, although not shown in the drawings, the stator 9 is fitted onto a cylindrical fixed shaft through a one-way clutch. Given that the lockup clutch 5 is disengaged, and that a speed ratio between the pump impeller 6 and the turbine runner 7 is small, a transmission torque can be multiplied by altering the spiral flow returning from the turbine runner 7 to the pump impeller 6 by the stator 9. The power transmission channel between the output shaft 3 and the input shaft 8 of the transmission thorough the oil serves as the “hydraulic route” of the present invention. In contrast, if the speed ratio between the pump impeller 6 and the turbine runner 7 is large, that is, if the oil flows behind the stator 9, the stator 9 is idled by the one-way clutch in order not to disturb the oil flow. The input shaft 8 of the transmission is inserted into the fixed shaft while being allowed to rotated relatively therewith.

Although not shown, the lockup clutch 5 is axially reciprocated toward and away from the inner face of the front cover to be selectively engaged therewith. When the lockup clutch 5 is in engagement, the output shaft 3 serving as the input member and the input shaft 8 of the transmission serving as the output member are mechanically connected to transmit torque therebetween. Given that the lockup clutch 5 is in partial engagement, the output shaft 3 is allowed to be connected with the input shaft 8 but a torque transmitting capacity of the lockup clutch 5 is reduced while causing a slippage. When the lockup clutch 5 is in partial engagement, a speed difference between the lockup clutch 5 and the front cover is kept within a predetermined range. Such speed difference may also be called a “differential speeds”. Accordingly, the power transmission channel between the output shaft 3 and the input shaft 8 of the transmission provided by completely or partially engaging the lockup clutch 5 serves as the “mechanical route” of the present invention. By contrast, when the lockup clutch 5 is in disengagement, the engine torque is transmitted through the above-explained hydraulic route. Specifically, the above-explained engagement state of the lockup clutch 5 is changed depending on a running condition of the vehicle such as a vehicle speed, an engine speed and so on. To this end, the lockup clutch 5 is controlled hydraulically by the conventional hydraulic control system through oil passages.

A first torsional damper 10 is disposed serially on an output side of the lockup clutch 5. Specifically, the first torsional damper 10 is comprised of a pair of disc-shaped drive member and driven member opposed coaxially to rotate relatively to each other, and coil springs arranged in a rotational direction are interposed therebetween. Therefore, as the conventional torsional damper, the coil springs are compressed by a relative rotation between the drive and driven members to elastically absorb torsional vibrations.

In turn, a pendulum dynamic damper 11 is disposed on an output side of the first torsional damper 10. The dynamic damper 11 is comprised of a rotary member 12 rotated integrally with the output shaft 3 or the input shaft 8 of the transmission, and a plurality of rolling members arranged in the rotary member 12. As the conventional pendulum damper, the rolling members 12 are oscillated by torque pulses on the rotary member 12 so that the torsional vibrations of the rotary member 12 are damped by the oscillating motions of the rolling members. Specifically, the rotary member 12 is formed of a driven member of the first torsional damper 10 or a member rotated integrally therewith. Accordingly, the dynamic damper 11 serves as the pendulum damper of the present invention.

Further, a second torsional damper 14 having a same structure as the first torsional damper 10 is disposed on an output side of the dynamic damper 11. According to the example shown in FIG. 1, the rotary member 12 of the dynamic damper 11 is connected to the driven member of the first torsional damper 10, and also to a drive member of the second torsional damper 14. On the other hand, a driven member of the second torsional damper 14 is connected to the input shaft 8 of the transmission. As shown in FIG. 1, the dynamic damper 11 is also connected to the turbine runner 7 of the torque converter 4 through the second torsional damper 14. Optionally, the driven member of the first torsional damper 10, the rotary member 12 and the drive member of the second torsional damper 14 may be formed integrally. Accordingly, the first torsional damper 10 serves as the elastic damper of the present invention, and the second torsional damper 14 serves as another elastic damper of the present invention.

Here will be explained an action of the power transmission system 1 thus structured. Given that the lockup clutch 5 is in disengagement, and that the speed ratio between the pump impeller 6 and the turbine runner 7 of the torque converter 4 is small, the engine torque is transmitted to the input shaft 8 of the transmission through the hydraulic route while being multiplied. In this case, the pulses of the engine torque and the torsional vibrations of the torque converter 4 are absorbed by a slippage between the pump impeller 6 and the turbine runner 7. By contrast, given that the lockup clutch 5 is in engagement, the engine torque is transmitted to the input shaft 8 of the transmission through the mechanical route, and the pulses of the engine torque and the torsional vibrations are sequentially damped by the first torsional damper 10, the dynamic damper 11 and the second torsional damper 14 on the way to the input shaft 8. In turn, given that the lockup clutch 5 is in partial engagement, the pulses of the engine torque and the torsional vibrations are absorbed by a slippage of the lockup clutch 5, and the engine torque is transmitted to the input shaft 8 of the transmission through both of the mechanical route and the hydraulic route.

Thus, the lockup clutch 5 is disposed on the mechanical route. In the power transmission system according to the first example, the first torsional damper 10 is disposed on the output side of the lockup clutch 5 in series, and the dynamic damper 11 is disposed on the output side of the first torsional damper 10. Therefore, the rotary member 12 will not be rotated together with the pump impeller 6 irrespective of engagement state of the lockup clutch 5. In addition, since the second torsional damper 14 is connected to the output side of the dynamic damper 14, the rotary member 12 will not be rotated together with the turbine runner 7 irrespective of engagement state of the lockup clutch 5. That is, the inertia moments of the pump impeller 6 and the turbine runner 7 will not be added to the inertia moment of the rotary member 12. According to the first example shown in FIG. 1, therefore, the inertia moment of the rotary member 12 in which the rolling member 13 is arranged can be reduced relatively to achieve a desired vibration damping performance of the dynamic damper 11. Consequently, the above-explained speed difference under the partial disengagement of the lockup clutch 5 is reduced so that the power loss resulting from a slippage of the lockup clutch 5 can be reduced. In addition, the dynamic damper 11 is allowed to be downsized by thus enhancing the vibration damping performance. Accordingly, a space required for arranging the dynamic damper 11 can be reduced so that the design flexibility can be increased. Further, fuel economy of the vehicle having the power transmission system 1 can be improved.

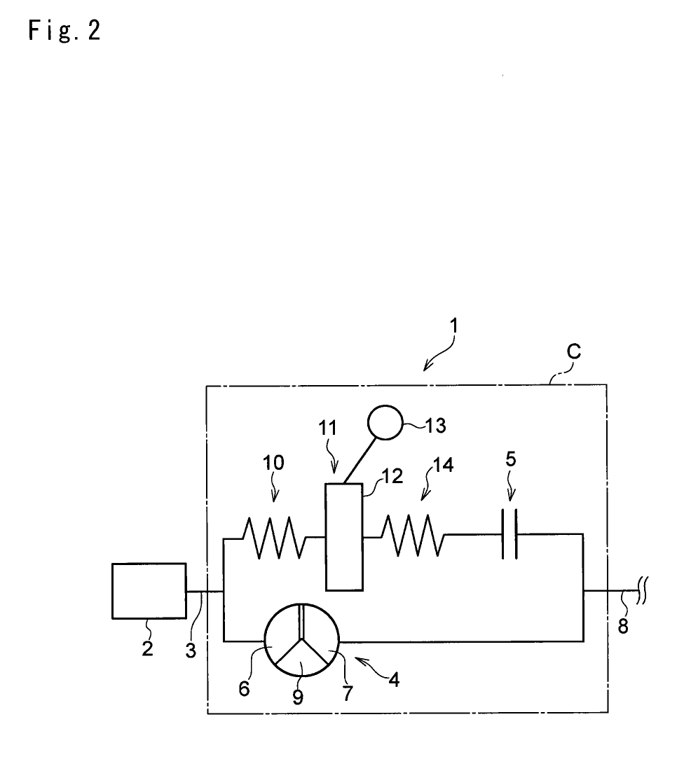

FIG. 2 shows the second example of the power transmission system 1. According to the second example, in the mechanical route, the second torsional damper 14 is disposed on the input side of the lockup clutch 5 in series, the dynamic damper 11 is disposed on the input side of the second torsional damper 14, and the first torsional damper 10 is disposed on the input side of the dynamic damper 11. Accordingly, the lockup clutch 5 is reciprocated toward and away from a driven member of the second torsional damper 14 or a member integrated therewith. The lockup clutch 5 is also connected to the input shaft 8 of the transmission to transmit a torque thereto.

Thus, as the first example shown in FIG. 1, the dynamic damper 11 is disposed on the output side of the first torsional damper 10. According to the second example, therefore, the rotary member 12 will not be rotated together with the pump impeller 6 irrespective of engagement state of the lockup clutch 5. Also, the second torsional damper 14 is disposed on the output side of the dynamic damper 14. Therefore, the rotary member 12 will not be rotated together with the turbine runner 7 irrespective of engagement state of the lockup clutch 5. That is, the inertia moments of the pump impeller 6 and the turbine runner 7 will also not be added to the inertia moment of the rotary member 12. Accordingly, the inertia moment of the rotary member 12 can be reduced while increasing the inertia moment of the rolling member 13 relatively with respect to that of the rotary member 12. In addition, the remaining advantages of the first example shown in FIG. 1 can also be achieved by the second example.

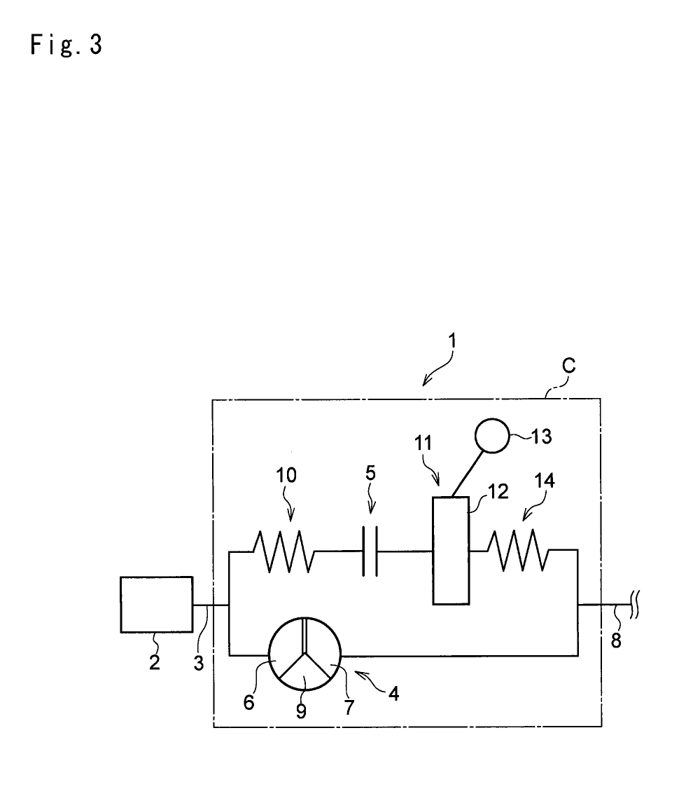

FIG. 3 shows the third example of the power transmission system 1. According to the third example, in the mechanical route, the first torsional damper 10 is disposed on the input side of the lockup clutch 5 in series, the dynamic damper 11 is disposed on the output side of the lockup clutch 5, and the second torsional damper 14 is disposed on the output side of the dynamic damper 11. Accordingly, the lockup clutch 5 is reciprocated toward and away from the driven member of the first torsional damper 10 or a member integrated therewith. For example, the rotary member 12 of the dynamic damper 11 is formed of the drive member of the second torsional damper 14 or a member rotated integrally therewith.

Thus, according to the third example, the lockup clutch 5 is disposed on the output side of the first torsional damper 10. Therefore, the rotary member 12 of the dynamic damper 11 will not be rotated together with the pump impeller 6 irrespective of engagement state of the lockup clutch 5. The second torsional damper 14 is also disposed on the output side of the dynamic damper 11, therefore, the rotary member 12 will not be rotated together with the turbine runner 7 irrespective of engagement state of the lockup clutch 5. That is, the inertia moments of the pump impeller 6 and the turbine runner 7 will also not be added to the inertia moment of the rotary member 12. Accordingly, the inertia moment of the rotary member 12 can be reduced while increasing the inertia moment of the rolling member 13 relatively with respect to that of the rotary member 12. In addition, the remaining advantages of the first and the second examples can also be achieved by the third example.

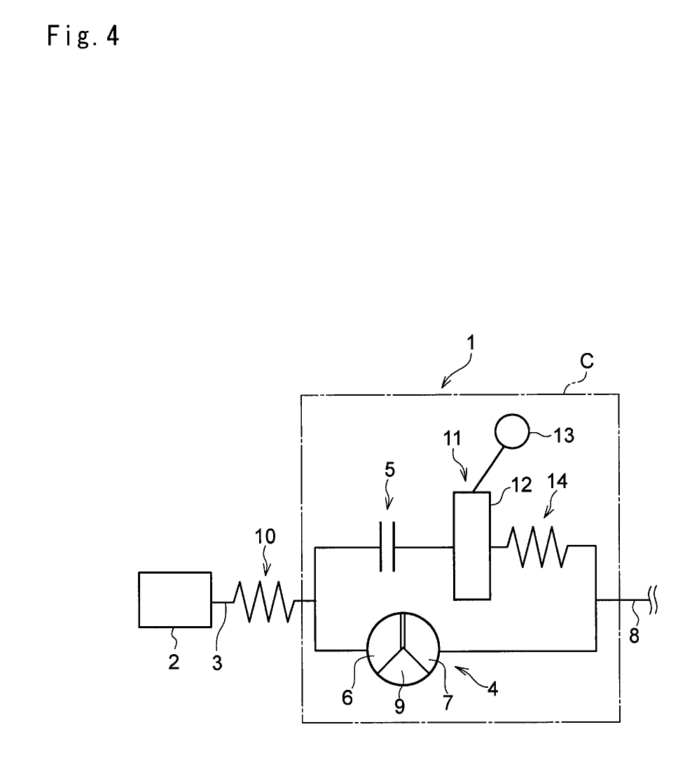

FIG. 4 shows the fourth example of the power transmission system 1. According to the fourth example, the first torsional damper 10 is disposed on the output shaft 3 of the engine 2. In the mechanical route, the dynamic damper 11 is disposed on the output side of the lockup clutch 5 in series, and the second torsional damper 14 is disposed on the output side of the dynamic damper 11. Specifically, the drive member of the first torsional damper 10 is connected to the output shaft 3, and the driven member of the first torsional damper 10 is connected to the lockup clutch 5 and to the pump impeller 6 to transmit power thereto. Thus, the lockup clutch 5 and the pump impeller 6 are connected to the driven member of the first torsional damper 10 while being parallel to each other. For example, the rotary member 12 of the dynamic damper 11 is formed of the drive member of the second torsional damper 14 or a member rotated integrally therewith. The driven member of the second torsional damper 14 and the turbine runner 7 are connected to the input shaft 8 of the transmission to transmit torque thereto.

Thus, according to the fourth example, the second torsional damper 14 is disposed on the output side of the dynamic damper 11. Therefore, the rotary member 12 will not be rotated together with the turbine runner 7 irrespective of engagement state of the lockup clutch 5. However, since the dynamic damper 11 is disposed on the output side of the lockup clutch 5, the rotary member 12 will be rotated together with the pump impeller 6 given that the lockup clutch 5 is in engagement. By contrast, given that the lockup clutch 5 is in partial engagement or disengaged, the rotary member 12 will not be rotated together with the pump impeller 6. According to the fourth example, therefore, the inertia moment of the rotary member 12 can be reduced relatively under the situation where the lockup clutch 5 is at least in partial engagement. That is, the inertia moment of the rolling member 13 can be increased relatively with respect to that of the rotary member 12.

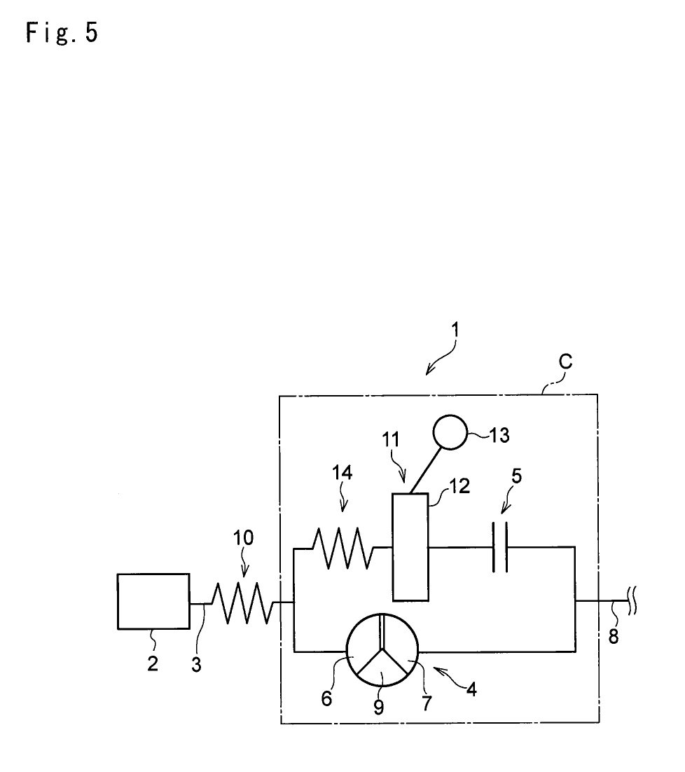

FIG. 5 shows the fifth example of the power transmission system 1. As the fourth example, the first torsional damper 10 is disposed on the output shaft 3 of the engine 2. According to the fifth example, in the mechanical route, the dynamic damper 11 is disposed on the input side of the lockup clutch 5 in series, and the second torsional damper 14 is disposed on the input side of the dynamic damper 11. Specifically, the drive member of the first torsional damper 10 is also connected to the output shaft 3, and the driven member of the first torsional damper 10 is connected to the pump impeller 6 and to the drive member of the second torsional damper 14. That is, the drive member of the second torsional damper 14 and the pump impeller 6 are connected to the driven member of the first torsional damper 10 while being parallel to each other. For example, the rotary member 12 of the dynamic damper 11 is formed of the driven member of the second torsional damper 14 or a member rotated integrally therewith. Accordingly, the lockup clutch 5 is reciprocated toward and away from the rotary member 12. The lockup clutch 5 and the turbine runner 7 are connected to the input shaft 8 of the transmission to transmit a torque thereto.

Thus, according to the fifth example, the dynamic damper 11 is disposed on the output side of the second torsional damper 14. Therefore, the rotary member 12 will not be rotated together with the pump impeller 6 irrespective of engagement state of the lockup clutch 5. However, since the dynamic damper 11 is disposed on the input side of the lockup clutch 5, the rotary member 12 will be rotated together with the turbine runner 7 given that the lockup clutch 5 is in engagement. By contrast, given that the lockup clutch 5 is in partial engagement or disengaged, the rotary member 12 will not be rotated together with the turbine runner 7. According to the fifth example, therefore, the inertia moment of the rotary member 12 can also be reduced relatively under the situation where the lockup clutch 5 is at least in partial engagement. That is, the inertia moment of the rolling member 13 can be increased relatively with respect to that of the rotary member 12.

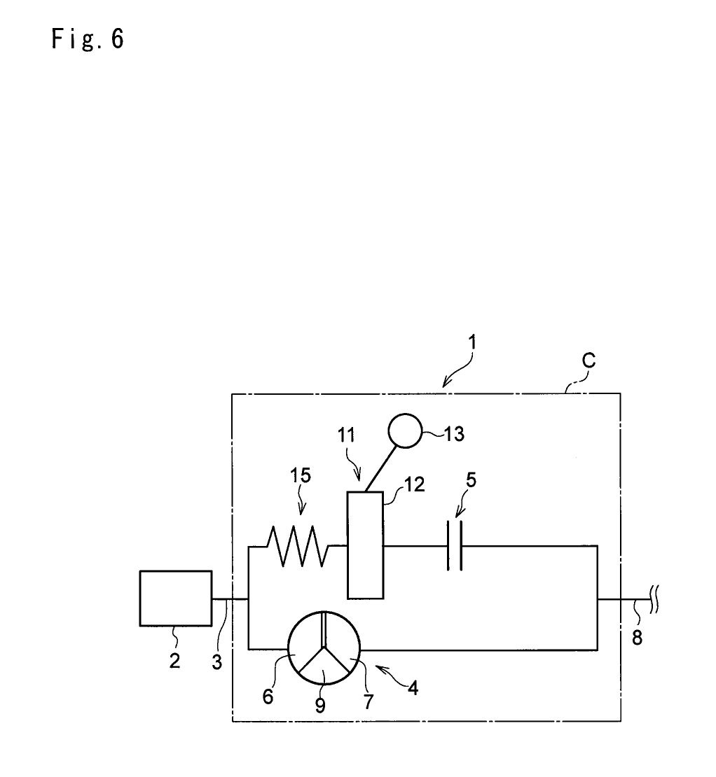

FIG. 6 shows the sixth example of the power transmission system 1. According to the sixth example, in the mechanical route, the dynamic damper 11 is disposed on the input side of the lockup clutch 5, and a torsional damper 15 is disposed on the input side of the dynamic damper 11. Specifically, the output shaft 3 of the engine 2 is connected to the pump impeller 6 and to the torsional damper 15 to transmit power thereto. A structure of the torsional damper 15 is similar to those of the foregoing torsional dampers 10 and 14. A drive member of the torsional damper 15 is connected to the front cover connected to the output shaft 3, and the driven member of the torsional damper 15 is connected to rotary member 12 of the dynamic damper 11. For example, the rotary member 12 of the dynamic damper 11 is formed of the driven member of the torsional damper 15 or a member rotated integrally therewith. Accordingly, the lockup clutch 5 is reciprocated toward and away from the rotary member 12 or the member rotated integrally therewith. The lockup clutch 5 and the turbine runner 7 are connected to the input shaft 8 of the transmission to transmit a torque thereto.

Thus, according to the sixth example, the dynamic damper 11 is disposed on the output side of the torsional damper 15. Therefore, the rotary member 12 will not be rotated together with the pump impeller 6 irrespective of engagement state of the lockup clutch 5. However, since the dynamic damper 11 is disposed on the input side of the lockup clutch 5, the rotary member 12 will be rotated together with the turbine runner 7 given that the lockup clutch 5 is in engagement. By contrast, given that the lockup clutch 5 is in partial engagement or disengaged, the rotary member 12 will not be rotated together with the turbine runner 7. According to the sixth example, therefore, the inertia moment of the rotary member 12 can also be reduced relatively under the situation where the lockup clutch 5 is at least in partial engagement. That is, the inertia moment of the rolling member 13 can be increased relatively with respect to that of the rotary member 12.

1-6. (canceled)

7. A power transmission system, comprising:
a hydraulic route for transmitting power between an input member and an output member through a fluid coupling adapted to transmit power by rotating a turbine runner by a fluid flow created by a pump impeller;
a mechanical route for transmitting power between the input member and the output member by mechanically connecting the input member and the output member by engaging a lockup clutch;
a pendulum damper that damps torsional vibrations of the output member or a rotary member rotated integrally therewith by an circumferential oscillating motion of a rolling member caused by the torsional vibrations; and
an elastic damper that damps the torsional vibrations by a relative rotation between a drive member and a driven member connected through an elastic member;
wherein the pendulum damper is disposed on the mechanical route in series with the lockup clutch between the input member and the output member;
wherein the elastic damper is disposed on an output side of the pendulum damper;
wherein the lockup clutch is disposed on an input side of the pendulum damper; and
wherein another elastic damper is disposed on the input side of the lockup clutch.

8. A power transmission system, comprising:
a hydraulic route for transmitting power between an input member and an output member through a fluid coupling adapted to transmit power by rotating a turbine runner by a fluid flow created by a pump impeller;
a mechanical route for transmitting power between the input member and the output member by mechanically connecting the input member and the output member by engaging a lockup clutch;
a pendulum damper that damps torsional vibrations of the output member or a rotary member rotated integrally therewith by a circumferential oscillating motion of a rolling member caused by the torsional vibrations;
an elastic damper that damps the torsional vibrations by a relative rotation between a drive member and a driven member connected through an elastic member;
wherein the pendulum damper is disposed on the mechanical route in series with the lockup clutch between the input member and the output member; and
wherein the lockup clutch is disposed on an output side of the pendulum damper;
wherein the elastic damper is disposed on an input side of the pendulum damper; and
wherein another elastic damper is disposed on the input member.

9. The power transmission system as claimed in claim 7, wherein the pendulum damper is arranged in the fluid coupling.

10. The power transmission system as claimed in claim 8, wherein the pendulum damper is arranged in the fluid coupling.
